(19) United States
(12) Patent Application Publication
(10) Pub. No.: US 2022/0056266 A1
(43) Pub. Date: Feb. 24, 2022

(54) POLYAMIDE COMPOSITE RESIN COMPOSITION FOR FUEL TUBE

(71) Applicants: Hyundai Motor Company, Seoul (KR); Kia Motors Corporation, Seoul (KR); Shinil Chemical Industry Co., Ltd., Ansan (KR)

(72) Inventors: Hyun Jun Kim, Suwon (KR); Chang Han Kim, Gwangju (KR); Jae Hwa Park, Suwon (KR); Keum Suk Seo, Ansan (KR); Dong Yol Ryou, Ansan (KR); Bo Ram Kwon, Namyangju (KR)

(21) Appl. No.: 17/136,338

(22) Filed: Dec. 29, 2020

(30) Foreign Application Priority Data
Aug. 18, 2020 (KR) 10-2020-0103082

(51) Int. Cl. C08L 77/06

(52) U.S. Cl. CPC C08L 77/06; C08L 2205/035; C08L 2205/025

(57) ABSTRACT

Disclosed is a polyamide composite resin composition that reduces an evaporative gas and an oligomer that can be generated from a fuel tube for a vehicle. The polyamide composite resin composition may include an amount of about 45 to 70% by weight of a polyamide resin; an amount of about 10 to 30% by weight of a nylon component; an amount of about 15 to 30% by weight of a thermoplastic elastomer; an amount of about 3 to 10% by weight of a clay component; and an amount of about 0.3 to 2.5% by weight of a carbon nanotube (CNT), all the % by weight based on the total weight of the polyamide composite resin composition.

### CROSS-REFERENCE TO RELATED APPLICATION

This application claims under 35 U.S.C. § 119(a) the benefit of priority to Korean Patent Application No. 10-2020-0103082 filed on Aug. 18, 2020, the entire contents of which are incorporated herein by reference.

### TECHNICAL FIELD

The present invention relates to a polyamide composite resin composition, which can reduce an evaporative gas and an oligomer that can be generated from a fuel tube for a vehicle.

### BACKGROUND

The regulations of exhaust emissions and volatile fuel leakage from vehicles have been tightened. The regulation of automotive fuel systems such as a fuel tube and a vapor hose due to environmental pollution shows a tendency toward enhancement. Depending on the tendency, due to reinforcement of specific laws against evaporative gases, each country plans to regulate 0.35 g/test (KLEV-3) for Korea E0, 2.0 g/test (EURO-6) for Europe E10, 0.3 g/test (LEV-3) for North America E10, and 0.65 g/test (China 6) for China E0 as a permissible level. Thus, there is a need to develop the fuel tube that requires improvement of fuel permeability resistance as well as affinity to a light material and bio fuel.

To cope with the regulations and to overcome the disadvantages, a multilayer (6 layer/5 layer/4 layer) system is frequently applied to the conventional fuel tube. However, in the case where a plastic material to which electric conductivity is given is applied to inner layers of the multilayer system, a problem of static electricity as well as a problem of, for instance, engine stalling due to high discharge of an oligomer may be caused. Further, a fluoropolymer may be included in the fuel tube, and be used to reduce the discharge of the oligomer. However, the fluoropolymer has difficulty in mass production due to a high price. Further, there is a problem in that mechanical properties deteriorate by a high content of conductive carbon black added to be able to inhibit static electricity from being generated from the inner layers of the fuel tube.

Thus, there is a need to develop a material for the fuel tube that has excellent mechanical physical properties and an excellent barrier characteristic against the evaporative gas and can reduce the oligomer while extrusion molding is possible in a monolayer system rather than the multilayer system.

### SUMMARY

In preferred aspects, provided is a polyamide composite resin composition that may include a polyamide resin, a nylon component including m-xylenediamine (MXD)-based modified nylon, a thermoplastic elastomer, a clay component including the MXD-based modified nylon, and a carbon nanotube (CNT).

The object of the present invention is not limited to the above-mentioned object. The object of the present invention will be more apparent from the following description, and be realized by means described in the claims and a combination thereof.

In an aspect, provided is a polyamide composite resin composition that may include: an amount of about 45 to 70% by weight of a polyamide resin; an amount of about 10 to 30% by weight of a nylon component; an amount of about 15 to 30% by weight of a thermoplastic elastomer; an amount of about 3 to 10% by weight of a clay component; and an amount of about 0.3 to 2.5% by weight of a carbon nanotube (CNT). All the % by weight is based on the total weight of the polyamide composite resin composition.

The term “polyamide resin” as used herein refers to a synthetic polymer formed of aliphatic or semi-aromatic polyamides. The polyamide resin is a thermoplastic resin formed of repeating units including aliphatic or aromatic groups which are linked by amide linkages that are formed by condensation reaction of amine and carboxylic acid.

The term “nylon component” as used herein a synthetic polymer formed of aliphatic or semi-aromatic polyamides, which is different from the polyamide resin discussed above. The nylon component is formed of repeating units including aliphatic or aromatic groups which are linked by amide linkages that are formed by condensation reaction of amine and carboxylic acid.

The term “clay component” as used herein refers to a natural soil material including various clay minerals, e.g., aluminum phyllosilicates, having fine size of the particles within a range of 1 to 10 μm, which is substantially less than a size of an ordinary fine grained soil.

The thermoplastic elastomer as used herein may be a rubber or rubber-like olefin resin including or formed of long chain-like molecules that are capable of recovering their original shape after being stretched. Exemplary elastomer or rubber may include natural rubber, neoprene rubber, buna-s and buna-n rubber, which are modified or unmodified alkyl or aliphatic chains having carbon backbones linked together by single (C—C) or double (C═C) bonds.

The polyamide composite resin composition may further include, with respect to 100 parts by weight of the polyamide composite resin composition, an amount of about 0.05 to 2.0 parts by weight of a heat-resistant stabilizer, an amount of about 0.05 to 3.0 parts by weight of a lubricant, and an amount of about 0.05 to 3.7 parts by weight of a viscosity thickener.

The nylon component may suitably include one or more selected from the group consisting of nylon 6, nylon 612, and m-xylenediamine (MXD)-based modified nylon.

A content of the MXD-based modified nylon may be an amount of about 30 to 100% by weight with respect to 100% by weight of the every nylon component.

The clay component may suitably include two or more selected from tabular montmorillonite, hectorite, saponite, and vermiculite.

The clay component may suitably include an organic material including tertiary or quaternary ammonium.

The organic material may suitably include one or more selected from bis(2-hydroxy-ethyl)methyl tallow ammonium and dimethyl hydrogenated-tallow ammonium.

The clay component may suitably include an organic material including any one or more selected from functional groups of phosphonium, maleate, succinate, acrylate, benzylic hydrogen, dimethyldistearyl ammonium, and oxazoline.

The CNT may have an average diameter of about 5 to 30 nm and an average length of about 1 to 20 sm.

The polyamide resin may suitably include polyamide 12.

The polyamide resin may further include one or more selected from a maleic resin and an epoxy resin.

The thermoplastic elastomer may suitably include an ethylene-octene copolymer grafted with maleic anhydride.

The polyamide composite resin composition may be economically excellent because an expensive fluoropolymer is not used. Since a fuel tube can be produced by extruding the polyamide composite resin composition in a monolayer system rather than a multilayer system, process steps and facilities can be reduced, and process efficiency can also be improved.

Further, since the polyamide composite resin composition includes, for instance, a polyamide resin satisfying a specific range, the fuel tube that has excellent mechanical physical properties and an excellent barrier characteristic against the evaporative gas and can reduce the oligomer can be produced using the polyamide composite resin composition.

Also provides is a fuel tube that comprises a polyimide composition resin composition as described herein.

Further provided is a vehicle that comprises a polyimide composition resin composition as described herein.

Still further provided is a vehicle that comprises a fuel tube as described herein.

Effects of the present invention are not limited by the above-mentioned effects. It should be understood that the effects of the present invention include all effects inferable from the following description.

Other aspects of the invention are disclosed infra.

### BRIEF DESCRIPTION OF THE DRAWINGS

The above and other features of the present invention will now be described in detail with reference to certain exemplary embodiments thereof illustrated in the accompanying drawings which are given herein below by way of illustration only, and thus are not limitative of the present invention, and wherein:

FIG. 1 shows a TEM photograph of a polyamide composite resin produced in Example 1 according to an exemplary embodiment of the present invention; and

FIG. 2 shows an SEM photograph of a polyamide composite resin produced according to Comparative Example 1 of the present invention.

### DETAILED DESCRIPTION

The above objects, other objects, features, and advantages of the present invention will be easily understood through the following, preferred embodiments taken in conjunction with the accompanying drawings. The present invention may, however, be embodied in different forms, and should not be construed as being limited to the embodiments set forth herein. Rather, these embodiments are provided such that the disclosed contents will be thorough and complete, and will fully convey the idea of the present invention to those having ordinary skill in the art.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

It should be understood that the terms “comprises”, “includes”, and/or “has” used herein specify the presence of stated features, integers, steps, operations, elements, components, or combinations thereof, but do not preclude the presence or addition of one or more other features, integers, steps, operations, elements, components, or combinations thereof.

Unless otherwise indicated, all numbers, values and/or expressions referring to quantities of ingredients, reaction conditions, polymer compositions, and formulations used herein are to be understood as modified in all instances by the term “about” because these numbers are inherently approximations that are reflective of, among other things, the various uncertainties of measurement encountered in obtaining such values.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 50%, 4%, 3%, 2%, 1%, 0.5%, 0.1%, 0.05%, or 0.01% of the stated value. Unless otherwise clear from the context, all numerical values provided herein are modified by the term “about.”

Further, in the case where a numerical range is disclosed herein, this range is continuous, and includes, unless otherwise indicated, all values from the minimum value to and including the maximum value of this range. Furthermore, in the case where this range refers to integers, unless otherwise indicated, all integers from the minimum value to and including the maximum value are included.

In the present specification, in the case where a range is described for a variable, it will be understood that the variable includes all values within the stated range including the end points described in the range. For example, a range of “5 to 10” may include any sub-range such as 6 to 10, 7 to 10, 6 to 9, 7 to 9, etc., as well as values of 5, 6, 7, 8, 9, and 10, and will be understood to include any value between integers that are reasonable within the category of the stated ranges such as 5.5, 6.5, 7.5, 5.5 to 8.5 and 6.5 to 9, and so on. In addition, for example, a range of “10% to 30%” may include any sub-range such as 10% to 15%, 12% to 18%, 20% to 30%, etc., as well as all integers including values of 10%, 11%, 12%, 13%, etc. and to and including 30%, and will also be understood to include any value between integers that are reasonable within the category of the stated ranges such as 10.5%, 15.5%, 25.5%, and the like.

In the present specification, a polyamide composite resin composition has an excellent barrier characteristic against an evaporative gas while being used for a fuel tube, but is not particularly limited as long as it can reduce an oligomer.

In an aspect, provided is a polyamide composite resin composition may include a polyamide resin, a nylon component, a thermoplastic elastomer/rubber, a clay component, and a carbon nanotube (CNT).

Preferably, the polyamide composite resin composition (“composition”) may include an amount of about 45 to 70% by weight of a polyamide resin, an amount of about 10 to 30% by weight of nylon component, an amount of about 15 to 30% by weight of a thermoplastic elastomer/rubber, an amount of about 3 to 10% by weight of a clay component, and an amount of about 0.3 to 2.5% by weight of a CNT. All the % by weight is based on the total weight of the composition. In addition, the polyamide composite resin composition may further include, with respect to 100 parts by weight of a composite resin composition, an amount of about 0.05 to 2.0 parts by weight of a heat-resistant stabilizer, an amount of about 0.05 to 3.0 parts by weight of a lubricant, and an amount of about 0.05 to 3.7 parts by weight of a viscosity thickener.

It should be noted that contents of components of the polyamide composite resin composition according to the present invention to be described below are based on 100% by weight of the polyamide composite resin composition. If the basis is changed, the changed basis is always shown clearly, and thus it will be clearly understood to those skilled in the art that the contents will be described on the basis of any component.

(1) Polyamide Resin

A polyamide resin is not particularly limited as long as it is a resin easy to extrude as a matrix material.

The polyamide resin may include one or more selected from the group consisting of usually well-known polyamide resins that can be used in the present invention, for instance polyamide 12 and polyamide 6, is not restricted to include a specific component. Preferably, the polyamide resin may include polyamide 12 that is easy to extrude as a material, has high toughness and excellent wear resistance and excellent oil resistance to oil, grease, and fuel, is excellent in low moisture absorption, and has excellent adhesion performance between resins.

Further, the polyamide resin may further include one or more selected from a maleic resin and an epoxy resin in order to increase a molecular weight. Addition of the maleic resin or the epoxy resin may adjust the molecular weight through an extrusion reaction with a —NH functional group of a polyamide terminus and a resin including a maleic or epoxy series. Further, one or more selected from the maleic resin and the epoxy resin may be suitably included by about 0.01 to 15 parts by weight with respect to 100 parts by weight of the polyamide resin. When the content is less than about 0.01 parts by weight, an effect of adjusting a polymer molecular weight may not be sufficient, an effect of thickening viscosity may not be produced, and molding performance during blow molding may be decreased. When the content is greater than about 15 parts by weight, an effect of thickening polymer viscosity may be excessive, blow molding may not be possible, and moldability may be decreased.

Further, relative viscosity (RV) of the polyamide resin may range from about 2.0 to about 3.6. When the RV is less than about 2.0, blow molding may not be possible due to a parison sagging phenomenon during extrusion blow molding because of an increase in fluidity. When the RV is greater than about 3.6, and when compressed air is injected into a parison during blow molding, a thickness may not be uniformly adjusted, and a product having a uniform thickness may not be made.

A content of the polyamide resin may be about 45 to 70% by weight with respect to 100% by weight of the polyamide composite resin composition. If the content of the polyamide resin is less than about 45% by weight, an effect of improving chemical resistance and thermal resistance may be weak. When the content of the polyamide resin is greater than about 70% by weight, a drop in impact resistance at room and low temperatures and a fall in blow moldability may occur.

(2) Nylon Component

Nylon component is not particularly limited as long as it can improve chemical resistance of a fuel tube made of a polyamide composite resin composition including the nylon component and a barrier characteristic against an evaporative gas.

The nylon component may include one or more selected from the group consisting of usually well-known nylons that can be used in the present invention, for instance nylon 6, nylon 612, m-xylenediamine (MXD)-based modified nylon, nylon 66, nylon 6-nylon 66 copolymer, nylon 610, nylon 46, nylon 11, and nylon 12, and is not restricted to include a specific component. The nylon component preferably may include one or more selected from the group consisting of nylon 6 having excellent gas barrier performance and excellent mechanical properties and heat-resistant performance, nylon 612 having low moisture absorption, a large molecular weight, and excellent adhesion performance, and MXD-based modified nylon having excellent gas barrier performance.

The MXD-based modified nylon included in the nylon component may be modified nylon, as a material of which a dispersion layer may be formed, in which MI measured at a temperature of about 275° C. is about 0.5, may form a dispersion layer having a laminar structure form when mixed with polyamide, and may be characterized by an excellent gas barrier characteristic. Since the dispersion layer may be sensitively changed according to a molding temperature, the molding temperature may be suitably adjusted to about 275° C. or less. The MXD-based modified nylon may be MXD 6 nylon, and may further include one or more selected from aromatic nylon and amorphous nylon. A content of the MXD-based modified nylon may be about 30 to 100% by weight with respect to 100% by weight of the every nylon component. When the content of the MXD-based modified nylon is less than about 30% by weight, laminar structure may not be sufficiently made for increasing a gas barrier characteristic against gasoline as well as mixed fuel in which gasoline and alcohol are mixed, and thus a gas barrier performance effect can be weak. When the content of the MXD-based modified nylon is greater than about 100% by weight, mechanical properties are weakened.

A content of the nylon component may be about 10 to 30% by weight with respect to 100% by weight of the polyamide composite resin composition. When the content of the nylon component is less than about 10% by weight, chemical resistance and gas barrier performance are weakened. When the content of the nylon component is greater than about 30% by weight, blow extrusion performance may be decreased.

(3) Thermoplastic Elastomer/Rubber (Thermoplastic Olefin (TPO))

A thermoplastic elastomer or rubber (TPO) is not particularly limited as long as it can be included in the polyamide composite resin composition and improve dispersibility.

The thermoplastic elastomer or thermoplastic rubber (TPO) may include one or more selected from the group consisting of usually well-known thermoplastic elastomers or rubbers (TPOs) that can be used in the present invention, for instance, an ethylene-octene copolymer onto grafted with maleic anhydride and an ethylene-propylene-diene-monomer (EPDM) grafted with maleic anhydride. The thermoplastic elastomer may suitably include an ethylene-octene copolymer grafted with maleic anhydride, which can secure impact resistance because a small content thereof may increase a dispersion force to reduce a size of a rubber pore and may give no obstacle to a laminar structure preventing gas permeation.

The thermoplastic elastomer/rubber (TPO) may be added to the polyamide composite resin composition in order to react with a chain of the polyamide resin to improve dispersibility. In comparison to the ethylene-propylene-diene-monomer (EPDM) of the related art, the thermoplastic elastomer/rubber (TPO) may secure impact resistance because a small content thereof may increase a dispersion force to reduce a size of a pore and may give no obstacle to a laminar structure preventing gas permeation. The thermoplastic elastomer/rubber may be dispersed to a size of about 1 to 10 μm using a twin-screw extruder.

A content of the thermoplastic elastomer/rubber (TPO) may be an amount of about 15 to 30% by weight with respect to 100% by weight of the polyamide composite resin composition. When the content of the thermoplastic elastomer/rubber (TPO) is less than about 15% by weight, there is a disadvantage in that a low-temperature impact effect is reduced. When the content of the thermoplastic elastomer/rubber is greater than about 30% by weight, physical properties of reinforcing an impact may be reduced.

(4) Clay Component

A clay component is not particularly limited as long as it can reinforce chemical resistance of a fuel tube made of a polyamide composite resin composition including the clay component and a barrier characteristic against an evaporative gas.

The clay component may be a usually well-known clay that can be used in the present invention, for instance tabular montmorillonite, hectorite, saponite, or vermiculite, preferably tabular montmorillonite, hectorite, saponite, or vermiculite, which is organically pre-treated with an organic material and may be a fine particle having a size of about 0.1 to 10 nm.

The organic material may be an organic material including tertiary or quaternary ammonium. The organic material may include one or more selected from bis(2-hydroxy-ethyl)methyl tallow ammonium and dimethyl hydrogenated-tallow ammonium. For example, montmorillonite organically treated with bis(2-hydroxy-ethyl)methyl tallow ammonium or montmorillonite organically treated with dimethyl hydrogenated-tallow ammonium may be used as the clay.

Further, the organic material may be an organic material that includes one or more selected from functional groups of phosphonium, maleate, succinate, acrylate, benzylic hydrogen, dimethyldistearyl ammonium, and oxazoline.

The clay component may suitably include one or more clays selected from tabular montmorillonite, hectorite, saponite, and vermiculite are mixed. The clay component may suitably include two or more clays selected from tabular montmorillonite, hectorite, saponite, and vermiculite are mixed and organically pre-treated. The organically pre-treated clay component may be produced by mixing two or more clays in a reaction tank when producing the clay and pre-treating the mixture with an organic material.

The clay component may be better dispersed in a resin than a single clay, may include an added amount of an excessively treated organic material at a small amount compared to a proper amount of an exchange reaction during organic pre-treatment in order to help the dispersion, and thereby may improve thermal stability to solve a problem of gas generation during blow molding in the polyamide composite resin composition.

A content of the clay component may be about 3 to 10% by weight with respect to 100% by weight of the polyamide composite resin composition. When the content of the clay component is less than about 3% by weight, an effect of improving a gas barrier characteristic is weak. When the content of the clay component is greater than about 10% by weight, impact performance may be reduced due to a sudden rise in tensile strength and flexural strength and a fall in elongation.

(5) Carbon Nanotube (CNT)

A carbon nanotube (CNT) is not particularly limited as long as it can remove static electricity in a fuel tube made of a polyamide composite resin composition including the carbon nanotube.

The carbon nanotube (CNT) may have a shape in which a hexagonal network consisting of carbon atoms may be supplied or provided in a rolled round. In this case, ends of the carbon nanotube may have a zigzag or armchair shape according to a rolled angle. Further, the rolled carbon nanotube may take a single-wall structure having a single wall and a multi-wall structure having multiple walls. In addition, the carbon nanotube may take a bundled nanotube in which a single wall or multiple walls are shaped in a bundle, a metal-atom-filled nanotube in which metal atoms are present, and so on.

The carbon nanotube may be included in the polyamide composite resin composition, which has an advantage in that mechanical properties such as flexural modulus (FM), flexural strength (FS), and tensile strength (TS) and heat-resistant properties such as a heat deflection temperature (HDT) can be improved, and static electricity in a fuel tube made of the mixture is removed to reduce a possibility of inflammation.

The carbon nanotube (CNT) may have an average diameter of about 5 to 30 nm and an average length of about 1 to 20 μm. When the average diameter is less than about 5 nm, an average length allowing conductivity may be shortened and thus the conductivity is not easily implemented. When the average diameter is greater than about 30 nm, a multiple cohesion phenomenon may occur, dispersibility may deteriorate, and conductivity may be weakened.

A content of the carbon nanotube (CNT) may suitably be about 0.3 to 2.5% by weight with respect to 100% by weight of the polyamide composite resin composition. When the content of the carbon nanotube is less than about 0.3% by weight, conductivity may not be sufficiently obtained and static electricity may not be prevented. When the content of the carbon nanotube is greater than about 2.5% by weight, surface resistance may not be obtained at a desired level of the present invention and a material cost may be increased.

(6) Other Additives

A heat-resistant stabilizer is not particularly limited as long as it can give a function of maintaining long-term heat-resistant properties. The heat-resistant stabilizer may include one or more materials selected from usually well-known heat-resistant stabilizers that can be used in the present invention, for instance group I metal halides of the periodic table of elements such as sodium halides, potassium halides, and lithium halides, cuprous halides, and cuprous iodine compounds, may include one or more selected from hindered phenols, hydroquinones, and aromatic amines, and is not restricted to include a specific component.

A content of the heat-resistant stabilizer may be about 0.05 to 2.0 parts by weight with respect to 100 parts by weight of the polyamide composite resin composition. When the content of the heat-resistant stabilizer is less than 0.05 parts by weight, an effect of improving the long-term heat-resistant properties may be weak. Even if the content of the heat-resistant stabilizer is greater than about 2.0 parts by weight, the long-term heat-resistant properties may not be accordingly increased compared to the added content.

A lubricant is not particularly limited as long as it can serve as an internal lubricant to induce a smooth flow during injection molding. The lubricant may include one or more selected from the group consisting of usually well-known lubricants that can be used in the present invention, for instance stearic acid, stearyl alcohol, and stearamide, and is not restricted to include a specific component. A content of the lubricant may suitably be about 0.05 to 2.0 parts by weight with respect to 100 parts by weight of the polyamide composite resin composition. When the content of the lubricant is less than about 0.05 parts by weight, a function of inducing a smooth flow during injection molding may be weak. Even if the content of the lubricant is greater than about 2.0 parts by weight, a lubricating characteristic may not be accordingly increased compared to the added content.

A viscosity thickener is not particularly limited as long as it can increase viscosity of the polyamide composite resin composition to obtain viscosity suitable for blow molding. The viscosity thickener may include one or more selected from the group consisting of usually well-known viscosity thickeners that can be used in the present invention, for instance a vinyl series, an epoxy series, a methacryloxy series, an amino series, a mercapto series, an acryloxy series, an isocyanate series, a styryl series, and an alkoxyoligomer series, and is not restricted to include a specific component. A content of the viscosity thickener may be about 0.05 to 3.7 parts by weight with respect to 100 parts by weight of the polyamide composite resin composition. When the content of the viscosity thickener is less than about 0.05 parts by weight, a viscosity thickening effect may be weak. When the content of the viscosity thickener is greater than about 3.7 parts by weight, blow moldability may be reduced.

### EXAMPLE

Hereinafter, the present invention will be described in greater detail through specific examples. The following examples are merely illustrative in order to help understanding of the present invention, and the scope of the present invention is not limited thereto.

### Examples 1 to 3 and Comparative Examples 1 to 8: Production of Polyamide Composite Resin

Preparation of Organically Pre-Treated Clay Component

First, montmorillonite, hectorite, and saponite which were dispersed in water and from which impurities were removed were added at a weight ratio of 1:1:1, and were mixed on a condition at a temperature of 60° C. while being agitated, and a clay component dispersion solution was produced. Next, dimethyl hydrogenated-tallow ammonium, which was tertiary ammonium that was adjusted to 4 to 5 pH and then dissolved in the clay component dispersion solution at a temperature of 60° C., was added in a reaction tank by 90 milli equivalents per 100 g of the clay component dispersion solution, and was subjected to an exchange reaction for about 20 to 60 minutes at a temperature of 60° C. while being agitated, and a clay component was produced. Then, the clay component reacted using a filtering device was dried in a fluid dryer, and then a powder having a size between 10 to 40 micrometers was obtained using a milling device.

Production of Polyamide Composite Resin

Examples 1 to 3 and Comparative Examples 1 to 8 were mixed at a component ratio set forth in Table 1 below, and then polyamide composite resins were produced using a twin-screw extruder. A resin, a rubber, a heat-resistant stabilizer, a lubricant, and a viscosity thickener were injected through a main feeder, and the organically pre-treated clay component was injected and produced through a side feeder. In the case where the clay component was injected into the main feeder, a coagulation phenomenon of the clay component might occur, and thus the clay component was preferably injected using the side feeder or a spray method. A device in which disordered kneading was possible to improve dispersibility could be used as a screw of the extruder. Further, an extrusion temperature in a kneading region was preferably maintained at a temperature of 250° C. or less. When the extrusion temperature was greater than 250° C., a domain size was excessively made fine, and a barrier characteristic could be reduced. The kneaded polyamide composite material was pelletized through a cutter, and then was dried using a dehumidifying dryer.

TABLE 1

| | Com. | Com. | Com. | Com. | Com. | Com. | Com. | Com. | Example | Example | Example |
|---|---|---|---|---|---|---|---|---|---|---|---|
| Item | Ex. 1 | Ex. 2 | Ex. 3 | Ex. 4 | Ex. 5 | Ex. 6 | Ex. 7 | Ex. 8 | 1 | 2 | 3 |
| Polyamide 12 | 57 | 48 | 48.5 | 61.5 | 53 | 64 | 43 | 84 | 51.5 | 47 | 59.5 |
| MXD 6 | | | | | 20 | 10 | | 10 | 10 | 10 | 10 |
| Nylon 612 | 20 | 20 | | | | | 20 | | | 20 | |
| Nylon 6 | | | 20 | | | | | | 20 | | |
| Rubber-g-MA | 20 | 25 | 25 | 30 | 20 | 20 | 30 | — | 15 | 20 | 25 |
| Clay1 | — | 3.0 | 3.0 | 4.0 | 3.0 | | 3.0 | | | | |
| Clay2 | | | | | | 2.0 | | 2.0 | 2.0 | 1.0 | 3.0 |
| CNT | | | | | | | | | 1.5 | 2.0 | 2.5 |
| Conductive | 3.0 | 4.0 | 3.5 | 4.5 | 4.0 | 4.0 | 4.0 | 4.0 | | | |
| carbon black | | | | | | | | | | | |

Com. Ex.: Comparative Example
(Unit: % by weight)
Polyamide 12: Polyamide 12 (polyamide resin)
MXD 6: M-xylenediamine (MXD) 6 nylon (MXD-based modified nylon)
Nylon 612: Polyamide 612 (polyamide resin)
Nylon 6: Polyamide 6 (polyamide resin)
Rubber-g-MA: Ethylene-octene copolymer (thermoplastic elastomer/rubber) onto which maleic anhydride was grafted
Clay 1: Montmorillonite clay
Clay 2: Clay component in which montmorillonite, saponite, and hectorite were mixed at a weight ratio of 1:1:1 and were organically pre-treated
CNT: Multi-hole carbon nanotube
Conductive carbon black: Carbon black master batch (CB/MB)

### Test Example: Evaluation of Mechanical Physical Properties and Evaluation of Gas Barrier Characteristic and Oligomer

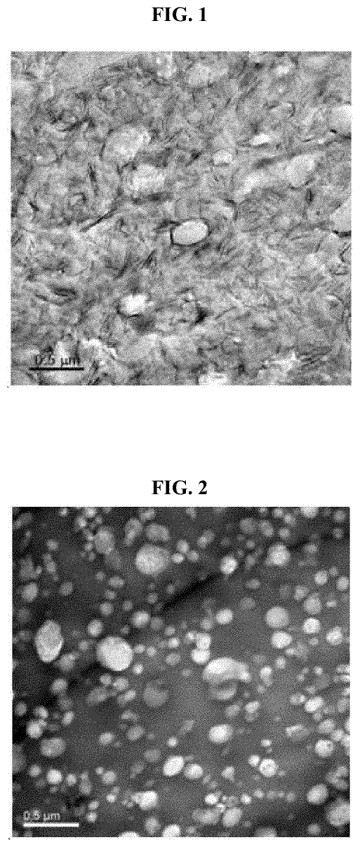

To examine physical properties, machinability, and gas barrier characteristics of moldings produced using the polyamide composite resins produced in Examples 1 to 3 and Comparative Examples 1 to 8, the following items were measured, and then the measured results were shown in Tables 2 and 3 below and FIGS. 1 and 2.

(1) Tensile strength (MPa): Measured at a speed of 50 mm/min on the basis of ASTM D638.

(2) Elongation (%): Measured at a speed of 50 mm/min on the basis of ASTM D638.

(3) Flexural modulus (MPa): Measured at a speed of 3 mm/min on the basis of ASTM D790.

(4) Izod impact strength (KJ/m²): Measured with respect to a temperature condition of a low temperature of −30° C. on a ¼″ notched condition on the basis of ASTM D256.

(5) Heat deflection temperature (° C.): Measured by applying a surface pressure of 0.45 MPa on the basis of ASTM D648.

(6) Electric resistance (0/cm): Surface resistance per unit area was measured using an electric resistance meter to which a metal bus bar was connected on the basis of ASTM D257.

(7) Room temperature burst pressure (kPa): Evaluated after a pipe was produced and then left for 3 hours at a temperature of 23° C. on the basis of ES31310-20/6.1.2.

(8) Barrier characteristic evaluation: A variation in weight was measured for two days after fuel E10 was filled in a fuel oil vessel and then was soaked for 14 days at a temperature of 60° C. on the basis of SAE J2665.

(9) Oligomer leaching evaluation: A pipe was produced, deposited in fuel E10 for 500 hours at a temperature of 23° C., left for 24 hours at a temperature of 0° C., filtered through filter paper, and dried, and then leached weight was measured.

TABLE 2

| | Condition | Com. | Com. | Com. | Com. | Com. | Com. | Com. | Com. | Example | Example | Example |
|---|---|---|---|---|---|---|---|---|---|---|---|---|
| Item | ASTM | Ex. 1 | Ex. 2 | Ex. 3 | Ex. 4 | Ex. 5 | Ex. 6 | Ex. 7 | Ex. 8 | 1 | 2 | 3 |
| Density | D 792 | 1.03 | 1.03 | 1.04 | 1.06 | 1.05 | 1.04 | 1.02 | 1.03 | 1.04 | 1.04 | 1.05 |
| Tensile strength | D 638 | 35 | 30 | 43 | 45 | 51 | 49 | 28 | 48 | 48 | 47 | 50 |
| [MPa] | | | | | | | | | | | | |
| Elongation (%) | | >500 | >500 | 350 | 300 | 400 | 400 | >500 | 300 | >500 | 300 | >500 |
| Flexural modulus | D 790 | 350 | 330 | 550 | 700 | 750 | 700 | 280 | 650 | 720 | 700 | 750 |
| [MPa] | | | | | | | | | | | | |
| Izod impact strength | D 256 | NB | NB | NB | NB | NB | NB | NB | NB | NB | NB | NB |
| (−30° C.)[KJ/m²] | | | | | | | | | | | | |
| Heat deflection | D 648 | 47 | 45 | 72 | 65 | 75 | 80 | 43 | 76 | 75 | 72 | 71 |
| temperature [° C.] | | | | | | | | | | | | |
| Electric resistance | D 257 | 6 × E⁷ | 2 × E⁸ | 3 × E⁷ | 8 × E⁶ | 9 × E⁷ | 4 × E⁷ | 5 × E⁸ | 6 × E⁷ | 9 × E⁶ | 4 × E⁶ | 5 × E⁵ |
| [Ω/cm] | | | | | | | | | | | | |

TABLE 3

| | | Com. | | Com. | | Com. | | Com. | | Com. | | Com. | |
|---|---|---|---|---|---|---|---|---|---|---|---|---|---|
| Item | Condition | Ex. 1 | | Ex. 2 | | Ex. 3 | | Ex. 4 | | Ex. 5 | | Ex. 6 | |
| Room | 23° C. × | 6500 | | 6300 | | 6500 | | 7600 | | 7200 | | 7000 | |
| temperature | 3 h ≥ | | | | | | | | | | | | |
| burst pressure | 5500 kPa | | | | | | | | | | | | |
| (kPa) | | | | | | | | | | | | | |
| Barrier | North America | 0.712 | g | 0.418 | g | 0.317 | g | 0.233 | g | 0.324 | g | 0.164 | g. |
| characteristic | LEV-3: E10 | | | | | | | | | | | | |
| evaluation | 0.30 g/test | | | | | | | | | | | | |
| | (2 days) | | | | | | | | | | | | |
| Oligomer | E10, room | 135 | mg | 37 | mg | 38 | mg | 26 | mg | 38 | mg | 5.4 | mg |
| leaching | temperature × | | | | | | | | | | | | |
| evaluation | 500 h −> | | | | | | | | | | | | |
| | 0° C. × | | | | | | | | | | | | |
| | 24 h −>room | | | | | | | | | | | | |
| | temperature × | | | | | | | | | | | | |
| | 24 h ≤ 255 mg | | | | | | | | | | | | |

| | Com. | | Com. | | Example | | Example | | Example | |
|---|---|---|---|---|---|---|---|---|---|---|
| Item | Ex. 7 | | Ex. 8 | | 1 | | 2 | | 3 | |
| Room | 6400 | | 5500 | | 7300 | | 7500 | | 7400 | |
| temperature | | | | | | | | | | |
| burst pressure | | | | | | | | | | |
| (kPa) | | | | | | | | | | |
| Barrier | 0.263 | g | 0.134 | g | 0.046 | g | 0.054 | g | 0.039 | g |
| characteristic | | | | | | | | | | |
| evaluation | | | | | | | | | | |
| Oligomer | 35 | mg | 6.7 | mg | 4.3 | mg | 6.2 | mg | 3.6 | mg |
| leaching | | | | | | | | | | |
| evaluation | | | | | | | | | | |

Referring to Tables 2 and 3, it could be found that Comparative Example 1 that did not include any clay component or clay had a NB level of low-temperature impact strength and distinguished barely from the other comparative examples and examples. Further, it could be found that, in the case of Comparative Examples 2 to 4 containing a montmorillonite clay alone, especially low-temperature impact strength was out of the question, but tensile strength of the physical properties was low. It could be found that this was because the montmorillonite clay was selectively dispersed in a polyamide matrix and evaluation of a gas barrier characteristic was not good. It could be found that, in the case of Comparative Examples 5 to 8, a difference in mechanical physical properties according to a difference in conductive dispersion performance according to injection of a small amount of CNT and the content of a conductive carbon black occurred.

In contrast, it could be found that, since Examples 1 to 3 included the clay component and were produced by a method in which the clay component was dispersed on both a rubber and nylon, as shown in Table 3, a barrier characteristic of a fuel gas was greatly improved, and an oligomer was reduced. Further, it was found that Examples 1 to 3 included a multi-hole carbon nanotube, and the multi-hole carbon nanotube was dispersed entirely on a rubber and nylon like the clay component and thus served to give electric conductivity without having an influence on the barrier characteristic. In addition, it could be found that blow molding was easy, especially tensile strength was greatly improved, and a flexural modulus and a heat deflection temperature were similar to existing items.

FIG. 1 is a TEM photograph of a polyamide composite resin produced in Example 1 according to an exemplary embodiment of the present invention. It could be found in FIG. 1 that an organically pre-treated clay component was dispersed onto a polyamide resin. Meanwhile, FIG. 2 is an SEM photograph of a polyamide composite resin produced in Comparative Example 1. It could be found in FIG. 2 that MXD 6 was not included, and thus no dispersion layer was formed.

Therefore, the polyamide composite resin composition according to various exemplary embodiments of the present invention is economically excellent because an expensive fluoropolymer is not used. Since a fuel tube can be produced by extruding the polyamide composite resin composition in a monolayer system rather than a multilayer system, process steps and facilities can be reduced, and process efficiency can also be improved. Further, since the polyamide composite resin composition according to various exemplary embodiments of the present invention includes, for instance, a polyamide resin satisfying a specific range, there is an advantage in that a fuel tube that has excellent mechanical physical properties and an excellent barrier characteristic against an evaporative gas and can reduce an oligomer can be produced using the polyamide composite resin composition.

What is claimed is:

1. A polyamide composite resin composition comprising:
an amount of 45 to 70% by weight of a polyamide resin;
an amount of 10 to 30% by weight of a nylon component;
an amount of 15 to 30% by weight of a thermoplastic elastomer;
an amount of 3 to 10% by weight of a clay component; and
an amount of 0.3 to 2.5% by weight of a carbon nanotube (CNT),
all the % by weight based on the total weight of the polyamide composite resin composition.

2. The polyamide composite resin composition of claim 1, further comprising, with respect to 100 parts by weight of the polyamide composite resin composition, an amount of 0.05 to 2.0 parts by weight of a heat-resistant stabilizer, an amount of 0.05 to 3.0 parts by weight of a lubricant, and an amount of 0.05 to 3.7 parts by weight of a viscosity thickener.

3. The polyamide composite resin composition of claim 1, wherein the nylon component comprises one or more selected from the group consisting of nylon 6, nylon 612, and m-xylenediamine (MXD)-based modified nylon.

4. The polyamide composite resin composition of claim 3, wherein a content of the MXD-based modified nylon is an amount of 30 to 100% by weight with respect to 100% by weight of the every nylon component.

5. The polyamide composite resin composition of claim 1, wherein the clay component comprises two or more selected from tabular montmorillonite, hectorite, saponite, and vermiculite.

6. The polyamide composite resin composition of claim 5, wherein the clay component comprises an organic material comprising tertiary or quaternary ammonium.

7. The polyamide composite resin composition of claim 6, wherein the organic material comprises one or more selected from bis(2-hydroxy-ethyl)methyl tallow ammonium and dimethyl hydrogenated-tallow ammonium.

8. The polyamide composite resin composition of claim 5, wherein the clay component comprises an organic material comprising any one or more selected from functional groups of phosphonium, maleate, succinate, acrylate, benzylic hydrogen, dimethyldistearyl ammonium, and oxazoline.

9. The polyamide composite resin composition of claim 1, wherein the CNT has an average diameter of 5 to 30 nm and an average length of 1 to 20 μm.

10. The polyamide composite resin composition of claim 1, wherein the polyamide resin comprises polyamide 12.

11. The polyamide composite resin composition of claim 1, wherein the polyamide resin further comprises one or more selected from a maleic resin and an epoxy resin.

12. The polyamide composite resin composition of claim 1, wherein the thermoplastic elastomer comprises an ethylene-octene copolymer grafted with maleic anhydride.

13. A fuel tube that comprises the polyamide composite resin composition of claim 1.

14. A vehicle that comprises the polyamide composite resin composition of claim 1.
